(19) United States
(12) Patent Application Publication
(10) Pub. No.: US 2015/0029457 A1
(43) Pub. Date: Jan. 29, 2015

(54) Screw-less rim lock and hinge eyewear and assembly method therefor

(71) Applicant: Felix Bystritsky, Brooklyn, NY (US)

(72) Inventor: Felix Bystritsky, Brooklyn, NY (US)

(21) Appl. No.: 14/376,741

(22) PCT Filed: Mar. 7, 2013
(86) PCT No.: PCT/US2013/029500

§ 371 Date: Aug. 5, 2014

Related U.S. Application Data
(60) Provisional application No. 61/685,257, filed on Mar. 14, 2012.
(60) Provisional application No. 61/772,065, filed on Mar. 4, 2013.

(51) Int. Cl. G02C 1/08; G02C 13/00; G02C 5/22; G02C 5/16

(52) U.S. Cl. CPC G02C 1/08; G02C 5/16; G02C 13/001; G02C 5/2209; G02C 2200/06
USPC 351/90; 351/178

(57) ABSTRACT

In preferred embodiments, the proposed eyeglass frame includes two glass-holding rims, each attached to an endpiece with upper and lower hinge loops coupled thereto. The endpiece includes split proximal and middle sections, and a solid distal section. The split includes a curvilined slit and a first window. The frame has two clamps with a second window and a groove. The clamp, preferably formed as a tube having a C-like or 0-like cross-section, operatively slides along the endpiece. The frame has two temples each with—an upper prong and—a lower prong furnished with outer protrusions, and—a middle prong therebetween, including—a strip-shaped portion,—a Z-shaped portion, and—a tongue with a tip. The lower and upper prongs diverge, forming a V-shape. The tongue and tip engage with the first and second windows during assembling. The proposed frame is easily assembled without special tools or skills

### CROSS-REFERENCE TO RELATED APPLICATIONS

This application is a U.S. national stage application of an international application PCT/US2013/02950 filed on 7 Mar. 2013, which international application claims priority of a US provisional application US61/685,257 filed on 14 Mar. 2012 and a US provisional application US61/772,065 filed on 4 Mar. 2013.

### FIELD OF THE INVENTION

The present invention relates to eyeglass (spectacles) frames, particularly to screw-less rim lock and screw-less hinge eyewear frames.

### BACKGROUND OF THE INVENTION

There is known European Patent EP 0863424 disclosing “The hinge connecting side-piece (4) to mounting is based on inherent tension in the metal. It has three lengthways slits at the end of the side-piece to form three free-standing springs (1-3) bent to make up a connecting element. This is joined in tension to a strap (8) on the spectacles frame and remains foldable to provide the hinge function. The two outer springs (1,3) are bent into a U-shape at their ends to grasp the mounting (5) parts (6,7) as compared with the centre spring (2) which is bent out of its original plane so as to fit into the strap slot (8) so that the right-hand side of this forms an end-stop for the side-piece when this is folded out for use. In this position, the two ends of the respective springs give rise to a triangle of tension.”

There is also known US Pat. Application Publication No. 20080137029 disclosing “Eyeglass frame, which consists of a frontal eyeglass rim and two eyeglass temples, which are linked to the frontal eyeglass rim by means of connecting clips.”

The aforementioned devices however have various shortcomings, e.g. being difficult for manufacturing and/or assembling, unreliable, expensive, etc. Therefore, consumers and providers still need an inexpensive screw-less eyewear convenient for assembling, servicing, and using.

### BRIEF SUMMARY OF THE INVENTION

The aforesaid problem has been solved in the present invention. In a preferred embodiment, the inventive eyeglass frame comprises:

(a) a pair of glass-holding rims, characterized with: an inner region and an outer region joined with each other through the inner regions thereof;

(b) an endpiece made of a predeterminedly flexible material and coupled to the rim in the outer region thereof; the endpiece includes: (b1) an essentially flat body characterized with:—longitudinal edges,—a proximal section adjacent to the rim,—a distal section remote from the rim, and—a middle section, located between said proximal section and said distal section; the flat body includes a solid part in the distal section, and is longitudinally split—within the proximal section, and—within the middle section, by forming a curvilined slit, a first window, and a hole bordering with said solid part; wherein the curvilined slit, the first window, and the hole are sequentially connected making a common split through the proximal and middle sections; and (b2) an upper hinge loop and a lower hinge loop coupled to the opposite longitudinal edges of the flat body in the proximal section thereof;

(c) a joint clamp including: (c1) a flat clamp base having a second window and a groove, and is capable of operatively externally sliding along the longitudinal edges of said endpiece until stopped by the hinge loops;

(d) a temple made of a predeterminedly flexible material, and characterized with a proximal portion being proximate to said rim; the proximal portion includes:—an upper prong,—a middle prong, and—a lower prong with a strip-like shape; wherein: the upper prong and the lower prong have an equal length and are furnished with outer protrusions coupled thereto, and the upper prong and the lower prong side-wise diverge in the direction toward said rim, thereby forming a widening V-shape; said outer protrusions are configured to operatively engage with the upper hinge loop and the lower hinge loop during the assembling; the upper prong and the lower prong are spaced from the middle prong by recessions (gaps); the middle prong is longer than the upper prong and the lower prong; the middle prong includes:—a strip-shaped portion, being most remote from said rim, is situated between the upper prong and the lower prong;—a Z-shaped bent portion connected to said strip-shaped portion;—a tongue portion having a first end connected to the Z-shaped bent portion and a second end; and—a tip connected to the second end of said tongue portion; and wherein: said joint clamp is capable of operatively sliding between the recessions; and the tongue portion and the tip are configured to operatively engage with the second window, the first window, and the groove is capable of receiving a fraction of the middle prong.

The inventive eyeglass frame has at least the following advantageous features:
first: the inventive eyeglass frame can be easily assembled and dissembled basically with two smooth motions;
second: the inventive design eliminates several extra parts;
third: the inventive design does not require any special tools or even commonly used tools, such as a screwdriver, pliers and etc.;
fourth: an average consumer without specific professional skills could replace the temples of another style, or color, material (such as metal, plastic, carbon fiber, titanium, wood, rubber etc.);
fifth: the inventive design of the hinge joint unit allows for securely keeping the lenses in the frame, provides for reliable connection of the temples in place;
sixth: the solid part of the endpiece lets an optician to put the lenses into the frame separating the halves of the rim, while keeping the endpiece together as a whole, so that it easily fits into the clamp; and
seventh: sometimes, though very rarely, it is necessary to open the rim very wide, i.e. the endpiece need be fully separated into two halves by braking the solid part, in which case it's still easy to fit the endpiece in the clamp, since the curve-lined slit will facilitate positioning both the halves in the only one proper position.

### BRIEF DESCRIPTION OF DRAWINGS

FIG. 1 illustrates an exploded view of an eyeglass frame according to a first preferred embodiment of the present invention.

FIG. 2 illustrates a lateral projection view of the eyeglass frame according to the preferred embodiment of the present invention, shown in FIG. 1.

FIG. 3 illustrates a lateral projection view of the eyeglass frame during the assembling progress, according to the preferred embodiment of the present invention, shown in FIG. 1.

FIG. 4 illustrates a lateral sectional view of a joint clamp of the eyeglass frame according to the preferred embodiment of the present invention, shown in FIG. 1.

FIG. 5 illustrates a plan view of the eyeglass frame according to the preferred embodiment of the present invention, shown in FIG. 1.

FIG. 6 illustrates a projection view of several elements in a region “A” of the eyeglass frame according to the preferred embodiment of the present invention, shown in FIG. 5.

FIG. 7 illustrates a projection view of several elements in a region “B” of the eyeglass frame according to the preferred embodiment of the present invention, shown in FIG. 5.

FIG. 8 illustrates a detail projection view of an upper prong and a middle prong being parts of the temple, which is a unit of the eyeglass frame, according to the preferred embodiment of the present invention, shown in FIG. 1.

FIG. 9 illustrates an exploded view of an eyeglass frame according to a second preferred embodiment of the present invention.

FIG. 10 illustrates a lateral projection view of the eyeglass frame according to the preferred embodiment of the present invention, shown in FIG. 9.

FIG. 11 illustrates a lateral projection view of the eyeglass frame during the assembling progress, according to the preferred embodiment of the present invention, shown in FIG. 9.

FIGS. 12a and 12b illustrate two lateral sectional views of a joint clamp of the eyeglass frame according to preferred embodiments of the present invention.

FIG. 13 illustrates a plan view of the eyeglass frame according to the preferred embodiment of the present invention, shown in FIG. 9.

FIG. 14 illustrates a projection view of several elements in a region “A” of the eyeglass frame according to the preferred embodiment of the present invention, shown in FIG. 13.

FIG. 15 illustrates a projection view of several elements in a region “B” of the eyeglass frame according to the preferred embodiment of the present invention, shown in FIG. 13.

FIG. 16 illustrates a detail projection view of a temple having an upper prong and a middle prong, which temple being a unit of the eyeglass frame, according to the preferred embodiment of the present invention, shown in FIG. 9.

FIGS. 17 a-j illustrate various optional shapes of a first window and a curvilined slit within an endpiece being a unit of the eyeglass frame, and of a second window within the joint clamp according to preferred embodiments of the present invention.

FIGS. 18 a-f illustrate various optional shapes of the middle prong according to preferred embodiments of the present invention.

FIGS. 19 a-e illustrate design ramifications of the inventive hinge unit adapted for solid rims without a split, or for semi-rimless frames without a split, or rimless frames without a split.

### DETAIL DESCRIPTION OF PREFERRED EMBODIMENTS OF THE INVENTION

While the invention may be susceptible to embodiment in different forms, there are shown in the drawings, and will be described in detail herein, specific exemplary embodiments of the present invention, with the understanding that the present disclosure is to be considered an exemplification of the principles of the invention.

### I. First Exemplary Embodiment of the Invention

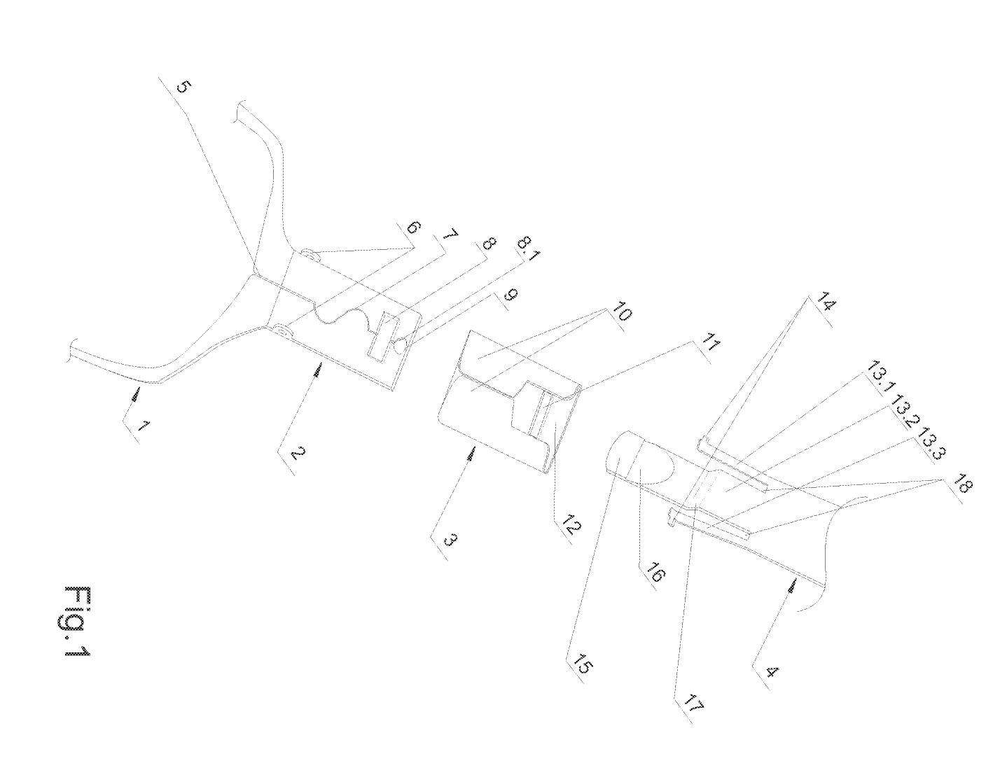

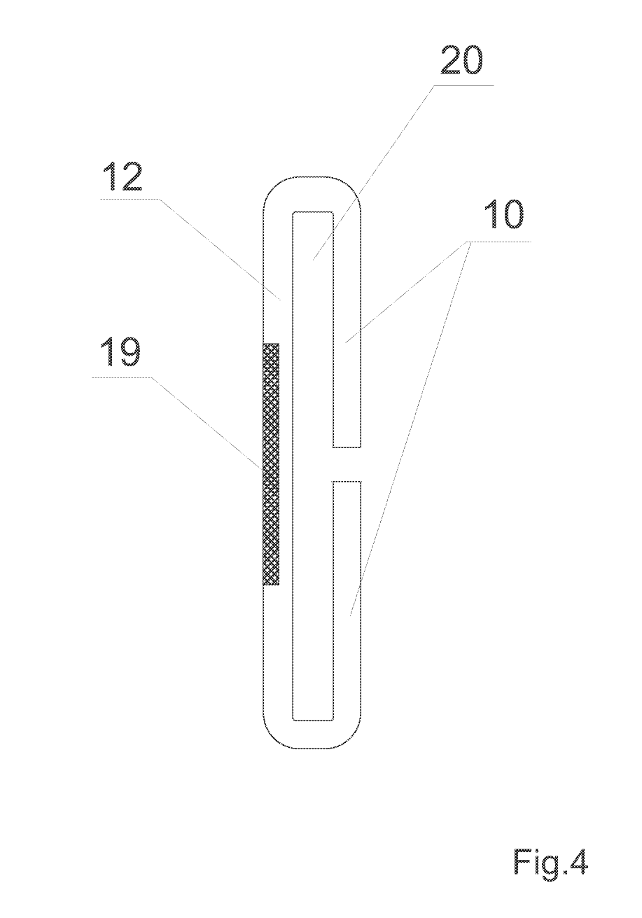

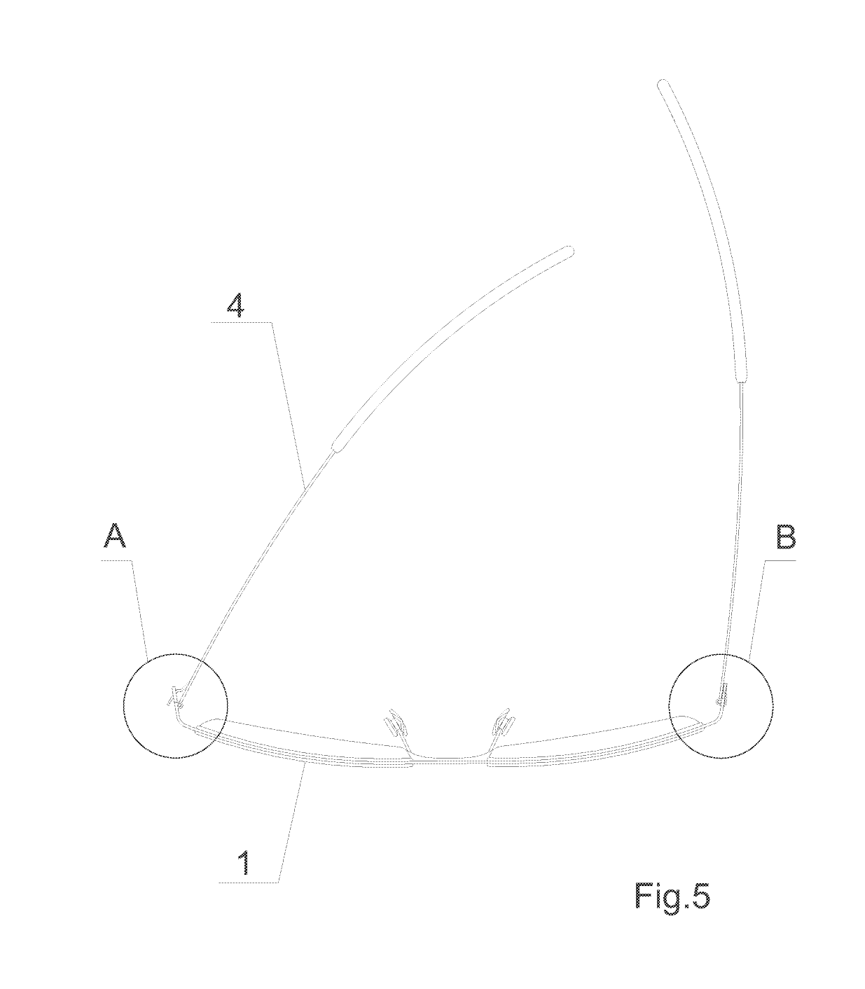

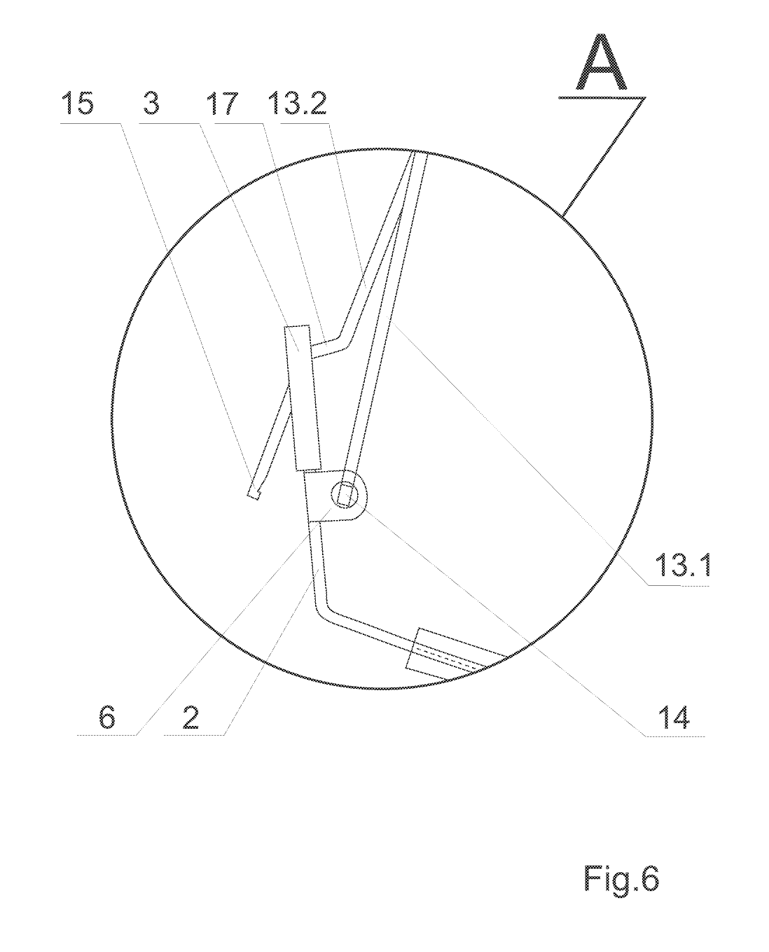

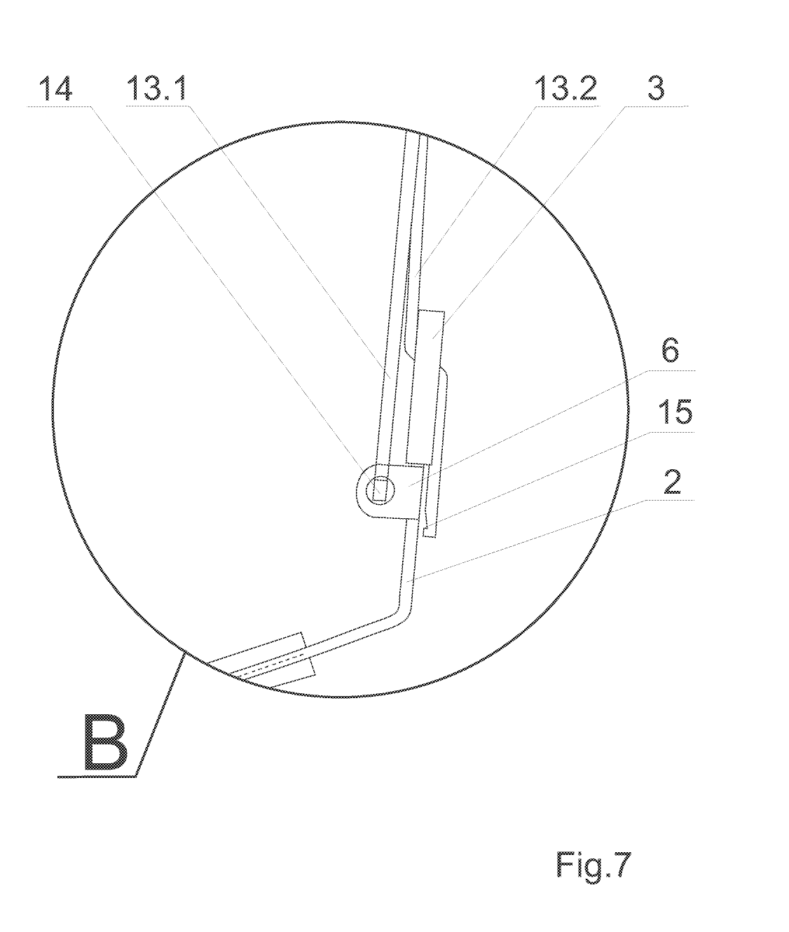

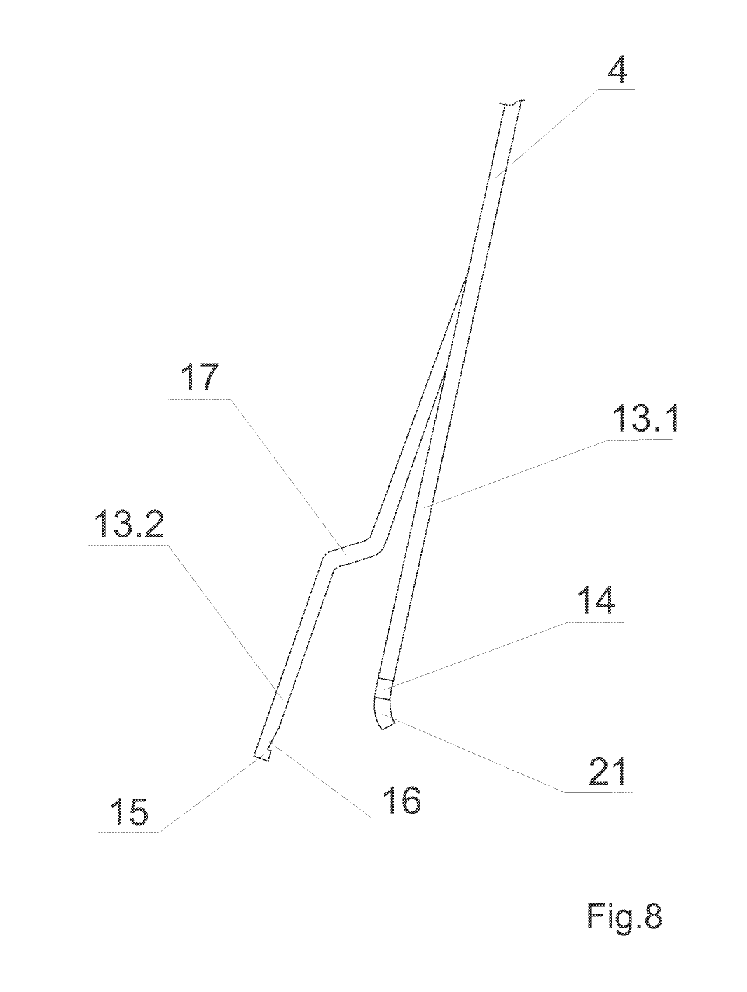

The eyeglass frame of the First Embodiment, shown in FIGS. 1-8 comprises:

(a) a pair of glass-holding rims (1), each said rim (1) is characterized with: an inner region and an outer region; said rims (1) are joined with each other through the inner regions thereof; each said rim (1) has a rim slit (5) in the outer region thereof;

(b) an endpiece (2) made of a predeterminedly flexible material and angularly coupled to each said rim (1) in the outer region thereof; said endpiece (2) includes:
(b1) an essentially flat body characterized with:—longitudinal edges,—a proximal section adjacent to the rim (1),—a distal section remote from the rim (1), and—a middle section, located between said proximal section and said distal section; said flat body includes a solid part (9) in the distal section; said flat body is longitudinally split:—within the proximal section, by forming an essentially straight line slit connected to said rim slit (5), and—within the middle section, by forming a curvilined slit (7), a window (8), and a hole (8.1) bordering with said solid part (9); wherein said straight line slit, the curvilined slit (7), the window (8), and the hole (8.1) are sequentially connected making a common split through the proximal and middle sections; and
(b2) an upper hinge loop (6) and a lower hinge loop (6) angularly coupled to the opposite longitudinal edges of said flat body in the proximal section thereof;

(c) a joint clamp (3) having a longitudinal axis, a proximal end being proximate to said rim (1), and a distal end being remote from said rim (1); said joint clamp (3) includes:
(c1) an essentially flat clamp base (12) having a window (11) transversely oriented in relation to the longitudinal axis of said joint clamp (3) and located closer to the distal end of said joint clamp (3) than to the proximal end of said joint clamp (3), the clamp base (12) includes a groove (19); and
(c2) two wings (10) having a flag-like shape with longer edges coupled with the clamp base (12) and shorter free edges; said wings (10) are folded up such that the free edges meet each other essentially over the longitudinal axis of said joint clamp (3), providing a clamp cutout, and wherein the window (11) and said clamp cutout overlap; said joint clamp (3) is capable of operatively externally sliding along the longitudinal edges of said endpiece (2) until it's stopped by the hinge loops (6), whereas the window (11) essentially coincides with the window (8);

(d) a temple (4) made of a predeterminedly flexible material, and characterized with a proximal portion being proximate to said rim (1); the proximal portion of said temple (4) includes:—an upper prong (13.1) with a strip-like shape,—a middle prong (13.2), and—a lower prong (13.3) with a strip-like shape; wherein: the upper prong (13.1) and the lower prong (13.3) have an equal length and are furnished with outer protrusions (14) coupled thereto close to the ends thereof; the upper prong (13.1) and the lower prong (13.3) side-wise diverge from the upper prong (13.1) and the lower prong (13.3) in the direction toward said rim (1), thereby forming a widening V-shape with a predetermined diverging angle; said outer protrusions (14) are configured to operatively engage with the upper hinge loop (6) and the lower hinge loop (6) during the assembling of said eyeglass frame; the upper prong (13.1) and the lower prong (13.3) are spaced from the middle prong (13.2) by recessions (18); the middle prong (13.2) is longer than the upper prong (13.1) and the lower prong (13.3); the middle prong (13.2) includes:—a strip-shaped portion most remote from said rim (1), the strip-shaped portion is situated between the upper prong (13.1) and the lower prong (13.3);—a Z-shaped bent portion (17) connected to said strip-shaped portion, said Z-shaped bent portion (17) provides for a step-up forward bend;—a tongue portion (16) having a first end connected to the Z-shaped bent portion (17) and a second end configured with a skewed cutout; and—a tip (15) connected to the second end of said tongue portion (16); and wherein: said joint clamp (3) is capable of operatively sliding between the recessions (18); the tongue portion (16) and the tip (15) are configured to operatively engage with the window (11), the window (8); and the groove (19) is configured to receive a fraction of the middle prong (13.2).

### II. Exemplary Method for Assembling the Eyeglass Frame of First Embodiment

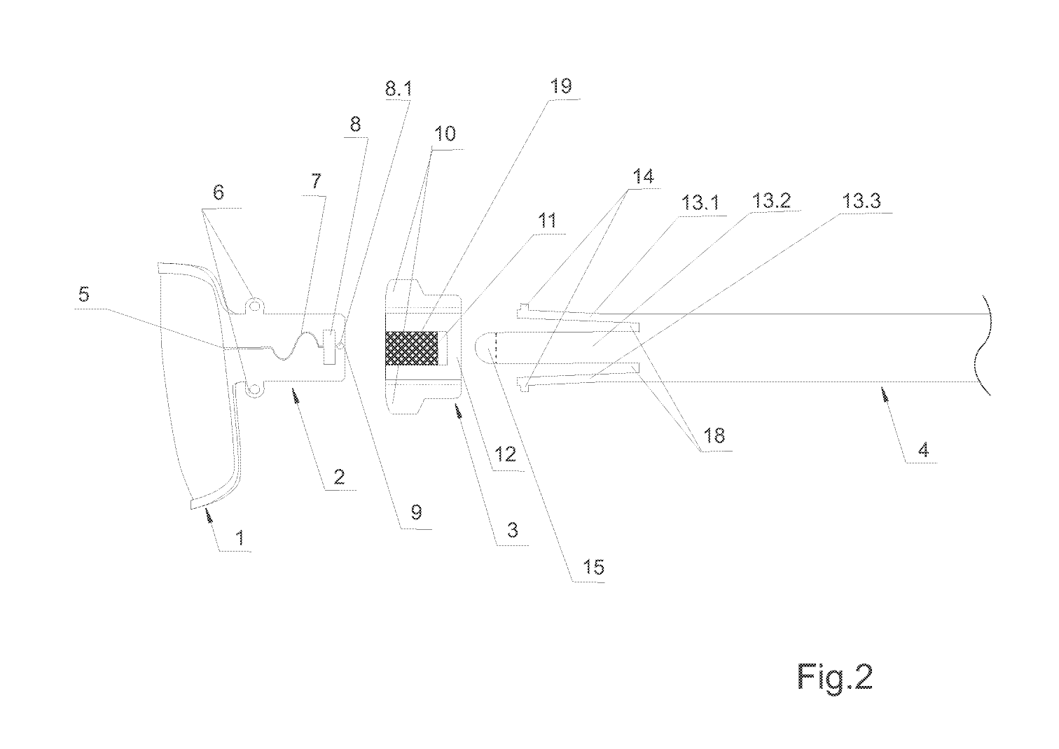

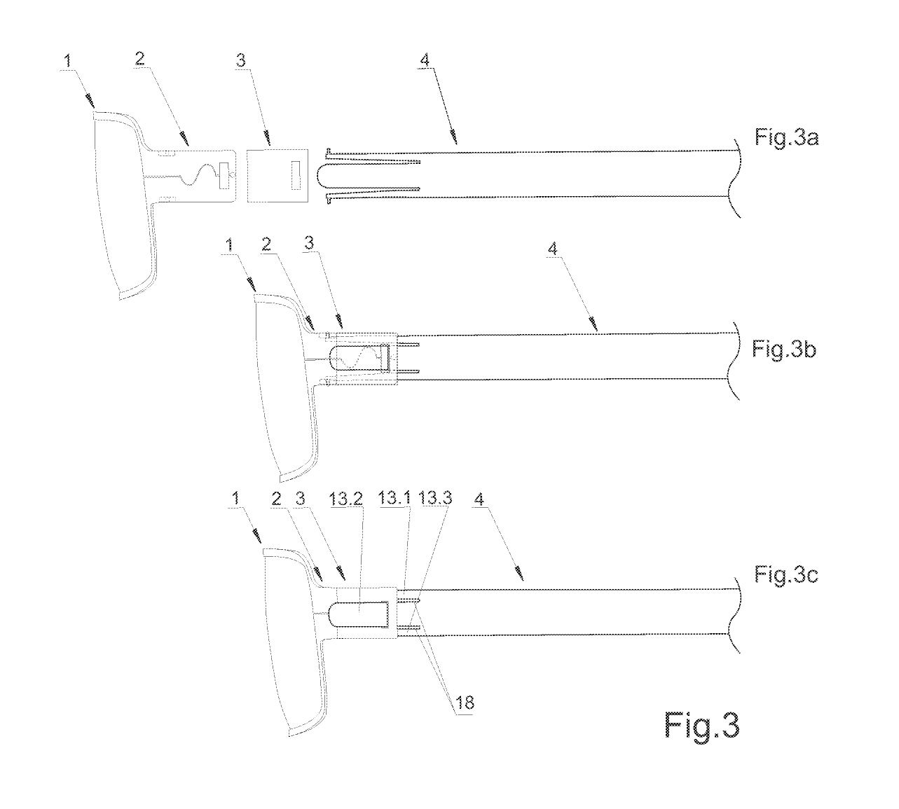

The inventive eyeglass frame shown in FIGS. 1-8 can be assembled, e.g. by a method (illustrated in FIGS. 2 and 3) comprising the following steps of:

(A) separating said endpiece (2) along the common split through the proximal and middle sections of the endpiece;

(B) inserting optical lenses into said rim (1) and joining said endpiece (2) along the common split through the proximal and middle sections;

(C) sliding said joint clamp (3) until it fits over said endpiece (2), wherein said joint clamp (3) reaches the hinge loops (6) and is stopped by them, then the window (11) essentially coincides with the window (8);

(D) folding the temple (4) down to said rim (1), sliding said middle prong (13.2) through the window (11) and the window (8);

(E) inwardly depressing the upper prong (13.1) against the lower prong (13.3), thereby narrowing the predetermined diverging angle therebetween, aligning the protrusions (14) of said upper prong (13.1) and said lower prong (13.3) with the corresponding hinge loops (6); and

(F) inserting said outer protrusions (14) into the corresponding hinge loops (6), and releasing said upper prong (13.1) and said lower prong (13.3), thereby completing the assembling of said eyeglass frame.

When the frame is assembled, and the temple (4) is folded down (closed) to said rim (1), said skewed cutout of the tongue (16) prevents the middle prong (13.2) from snapping out from the windows (8) and (11).

When the frame is assembled, and the temple (4) is folded up (open) from said rim (1), a predetermined fraction of the middle prong (13.2) is placed into the groove (19) maintaining a required configuration of the frame.

### III. Second Exemplary Embodiment of the Invention

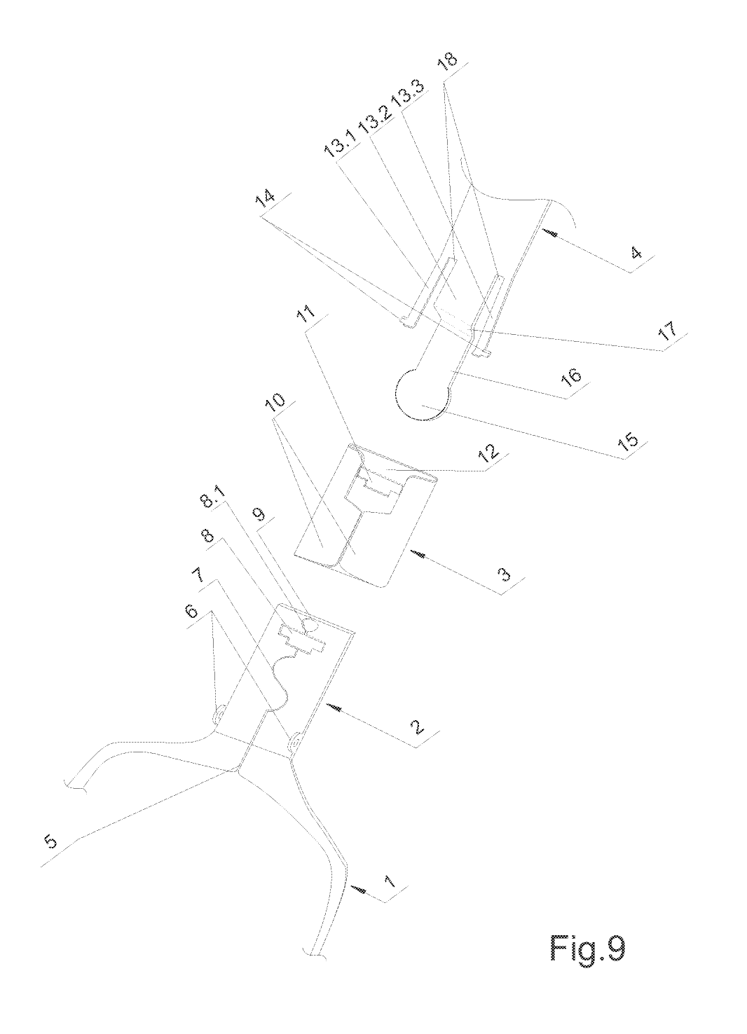

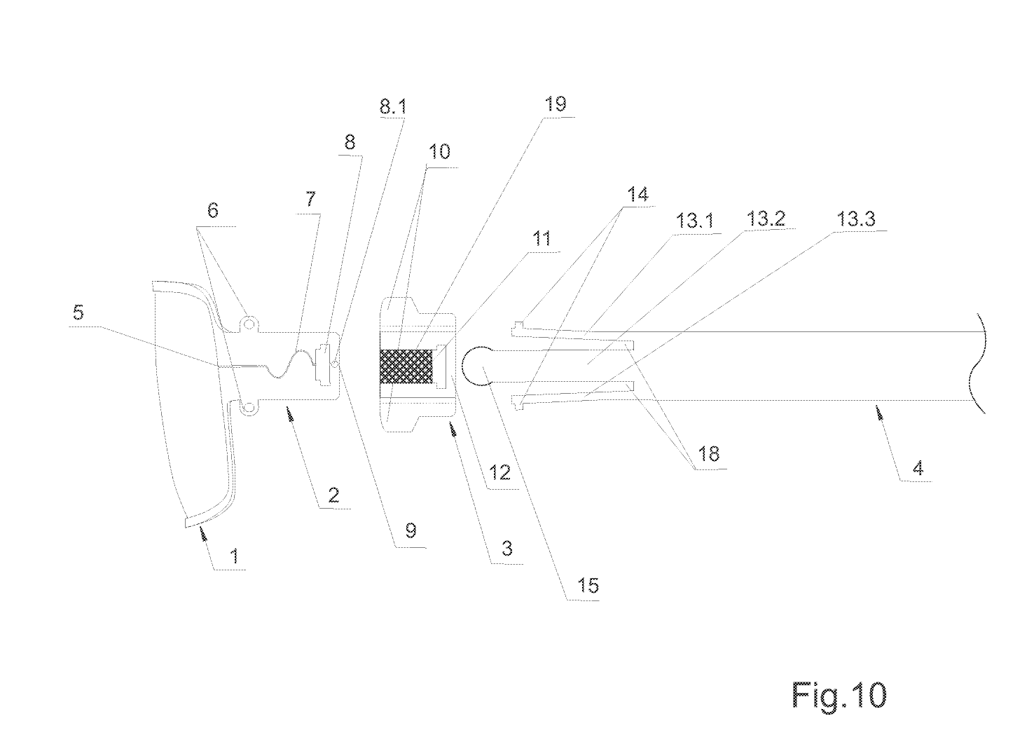

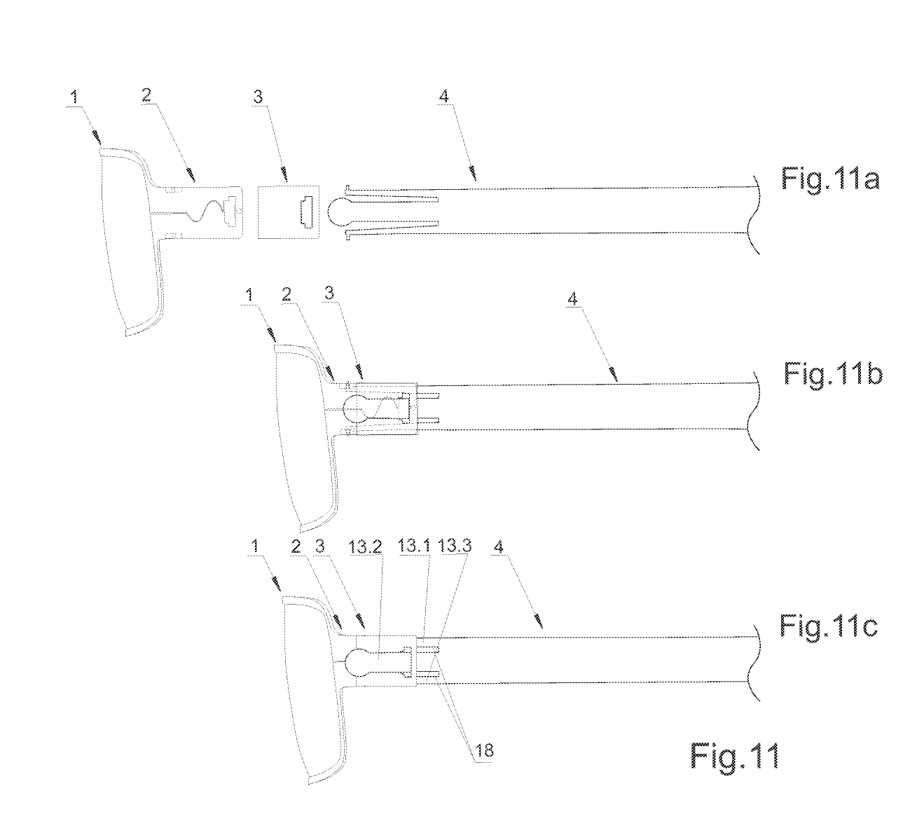

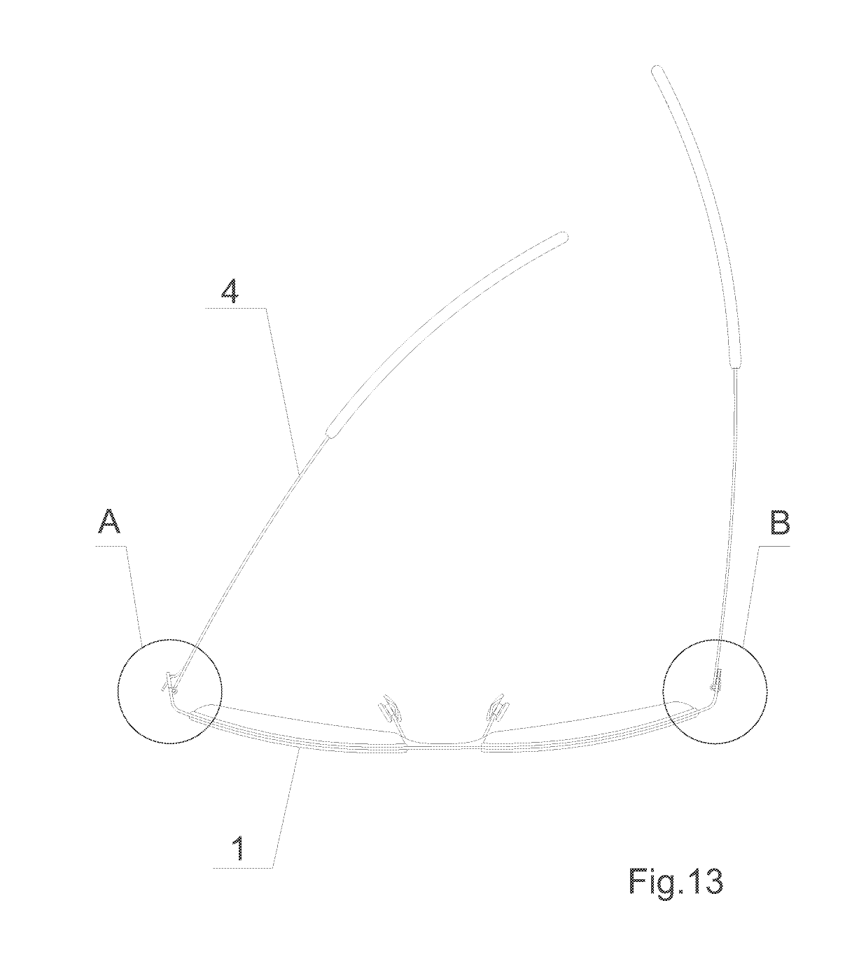

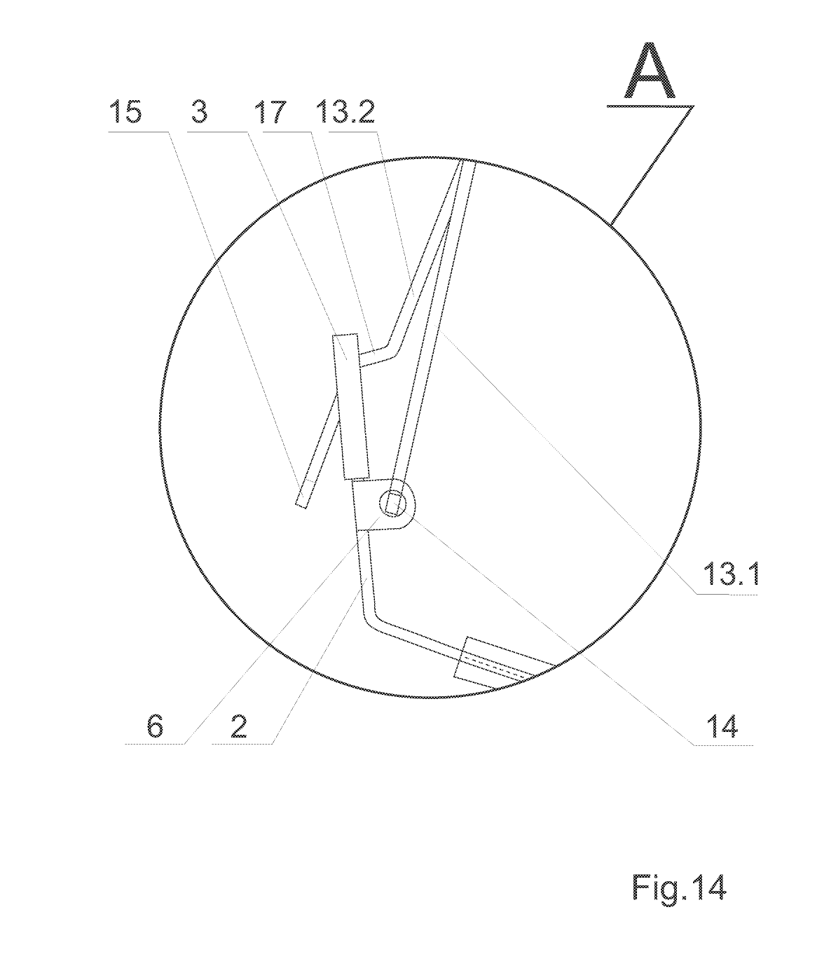

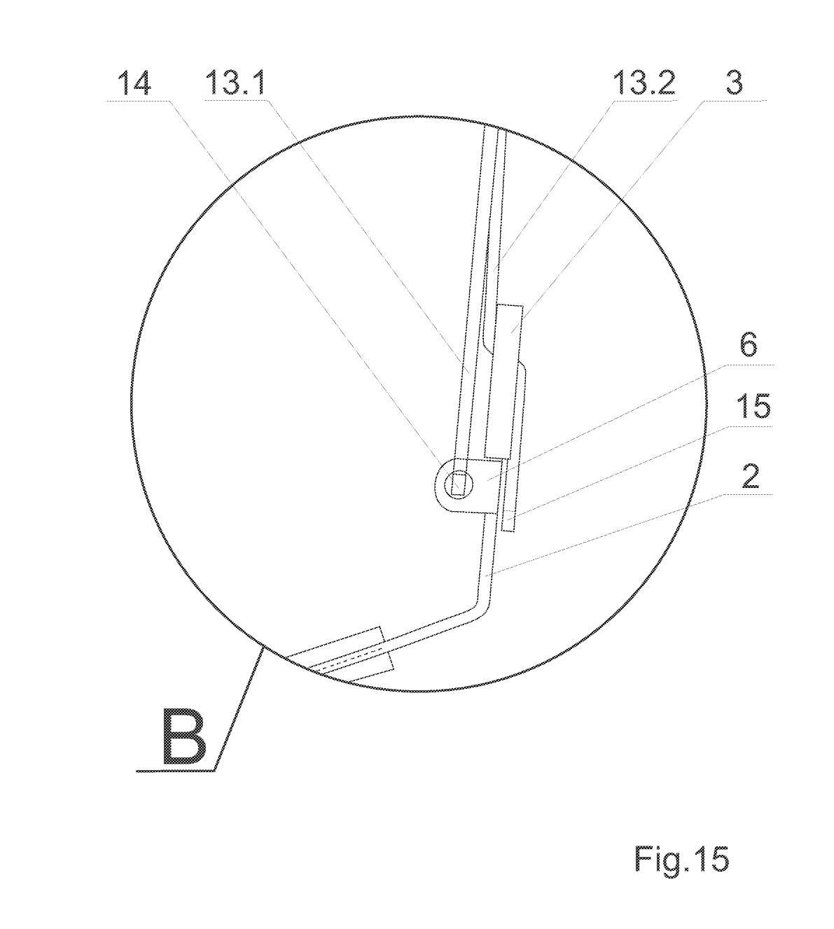

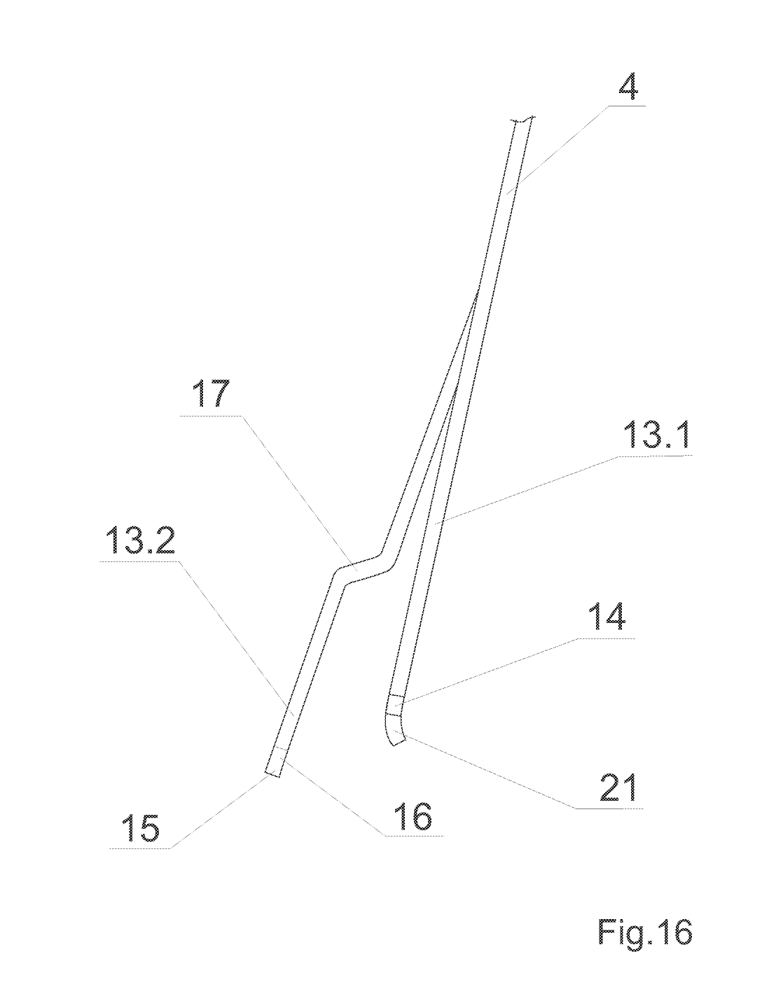

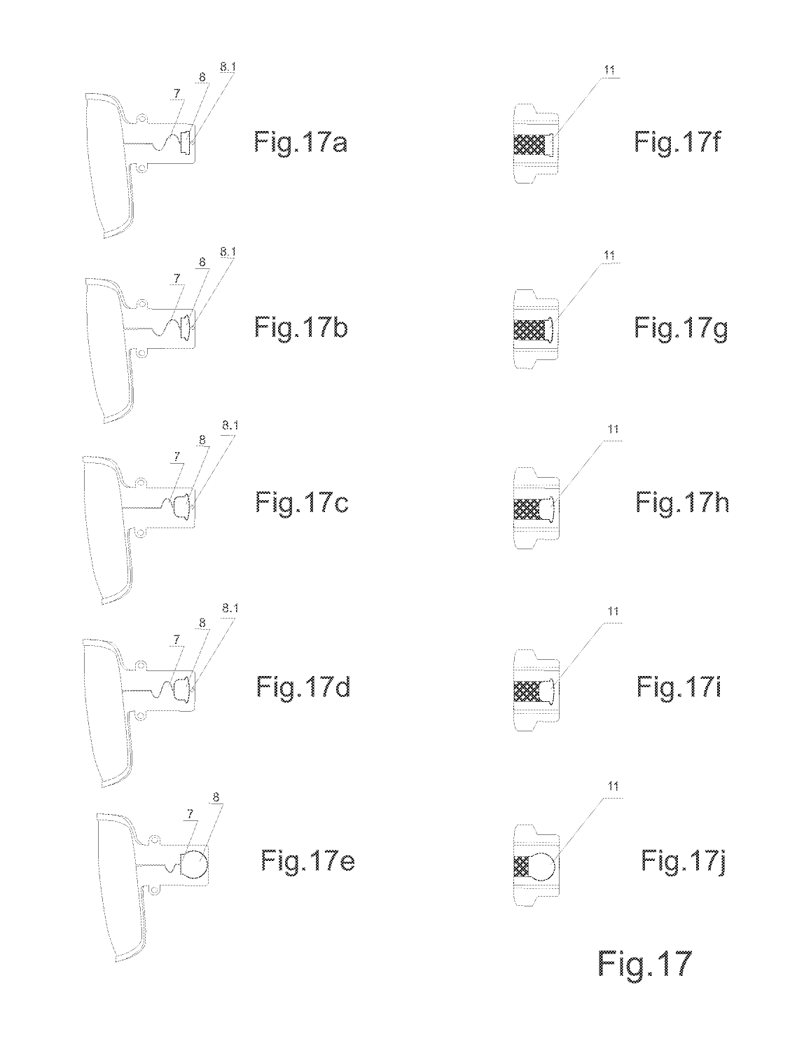

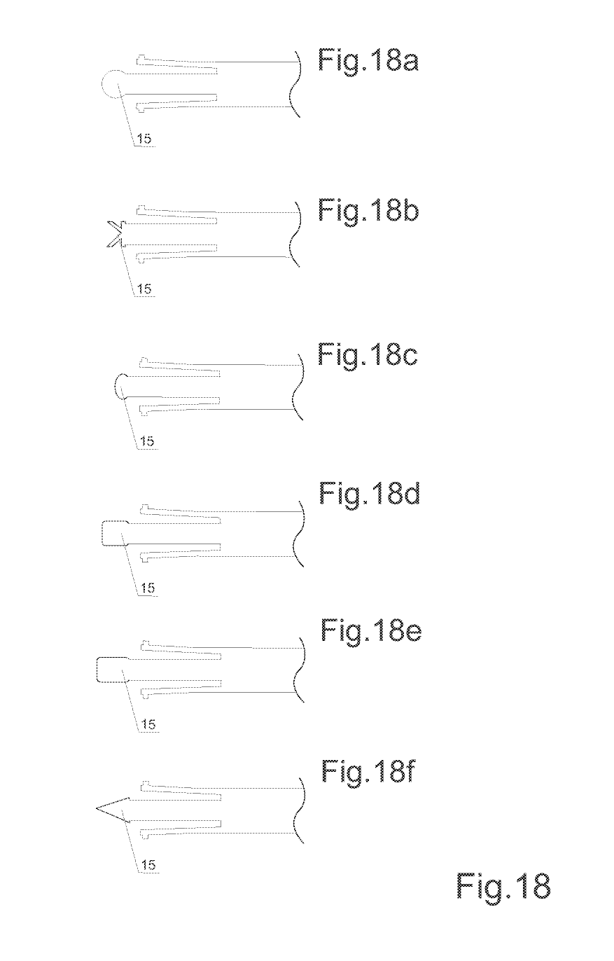

The eyeglass frame of the Second Embodiment, shown in FIGS. 9-18, comprises:

(a) a pair of glass-holding rims (1), each said rim (1) is characterized with: an inner region and an outer region; said rims (1) are joined with each other through the inner regions thereof; each said rim (1) has a rim slit (5) in the outer region thereof;

(b) an endpiece (2) made of a predeterminedly flexible material and angularly coupled to each said rim (1) in the outer region thereof; said endpiece (2) includes:
(b1) an essentially flat body characterized with:—longitudinal edges,—a proximal section adjacent to the rim (1),—a distal section remote from the rim (1), and—a middle section, located between said proximal section and said distal section; said flat body includes a solid part (9) in the distal section; said flat body is longitudinally split:—within the proximal section, by forming an essentially straight line slit connected to said rim slit (5), and—within the middle section, by forming a curvilined slit (7), a window (8), and an optional hole (8.1) bordering with said solid part (9); wherein said straight line slit, the curvilined slit (7), the window (8), and the optional hole (8.1) are sequentially connected making a common split through the proximal and middle sections; and
(b2) an upper hinge loop (6) and a lower hinge loop (6) angularly coupled to the opposite longitudinal edges of said flat body in the proximal section thereof;

(c) a joint clamp (3) having a longitudinal axis, a proximal end being proximate to said rim (1), and a distal end being remote from said rim (1); said joint clamp (3) including a clamp base (12) having a window (11) transversely oriented in relation to the longitudinal axis of said joint clamp (3) and located closer to the distal end of said joint clamp (3) than to the proximal end of said joint clamp (3), the clamp base (12) includes a groove (19); and said joint clamp (3) is capable of operatively externally sliding along the longitudinal edges of said endpiece (2) until the sliding is stopped by the hinge loops (6) and the window (11) essentially coincides with the window (8).

(d) a temple (4) made of a predeterminedly flexible material, and characterized with a proximal portion being proximate to said rim (1); the proximal portion of said temple (4) includes:—an upper prong (13.1) with a strip-like shape,—a middle prong (13.2), and—a lower prong (13.3) with a strip-like shape; wherein: the upper prong (13.1) and the lower prong (13.3) have an equal length and are furnished with outer protrusions (14) coupled thereto close to the ends thereof; the upper prong (13.1) and the lower prong (13.3) side-wise diverge from the upper prong (13.1) and the lower prong (13.3) in the direction toward said rim (1), thereby forming a widening V-shape with a predetermined diverging angle; said outer protrusions (14) are configured to operatively engage with the upper hinge loop (6) and the lower hinge loop (6) during the assembling of said eyeglass frame; the upper prong (13.1) and the lower prong (13.3) are spaced from the middle prong (13.2) by gaps or recessions (18); the middle prong (13.2) is longer than the upper prong (13.1) and the lower prong (13.3); the middle prong (13.2) includes:—a strip-shaped portion most remote from said rim (1), the strip-shaped portion is situated between to the upper prong (13.1) and the lower prong (13.3);—a Z-shaped bent portion (17) connected to said strip-shaped portion, said Z-shaped bent portion (17) provides for a step-up forward bend;—a tongue portion (16) having a first end connected to the Z-shaped bent portion (17) and a second end; and—a tip (15) connected to the second end of said tongue portion (16); and wherein: said joint clamp (3) is capable of operatively sliding between the recessions (18); and the tongue portion (16) and the tip (15) are configured to operatively engage with the window (11), the window (8), and the groove (19) receiving a fraction of the middle prong (13.2).

### IV. Specific Shapes of Certain Elements of the Inventive Eyeglass Frame

Some of the above described elements can be implemented in specific shapes (see FIGS. 9-18):

(i) the curvilined slit (7) may have a waveform with one of the following shapes: a jigsaw shape; one semicircle; at least two alternatively bulging semicircles; a broken line.

(ii) the window (11) and the window (8) may have a rectangular shape, a combination of two rectangles (a narrower and a wider one), a ‘sombrero’-like shape, or a shape including at least a portion of sphere or ellipsoid.

(iii) the hole (8.1) may have an oval or round shape.

(iv) the upper prong (13.1) and the lower prong (13.3) may have curvilined ends (21) situated behind the outer protrusions (14).

(v) the tip (15) may have a shape of at least a portion of a sphere or an ellipsoid; or a ‘mushroom’-like shape; or an arrow shape; or a polygon.

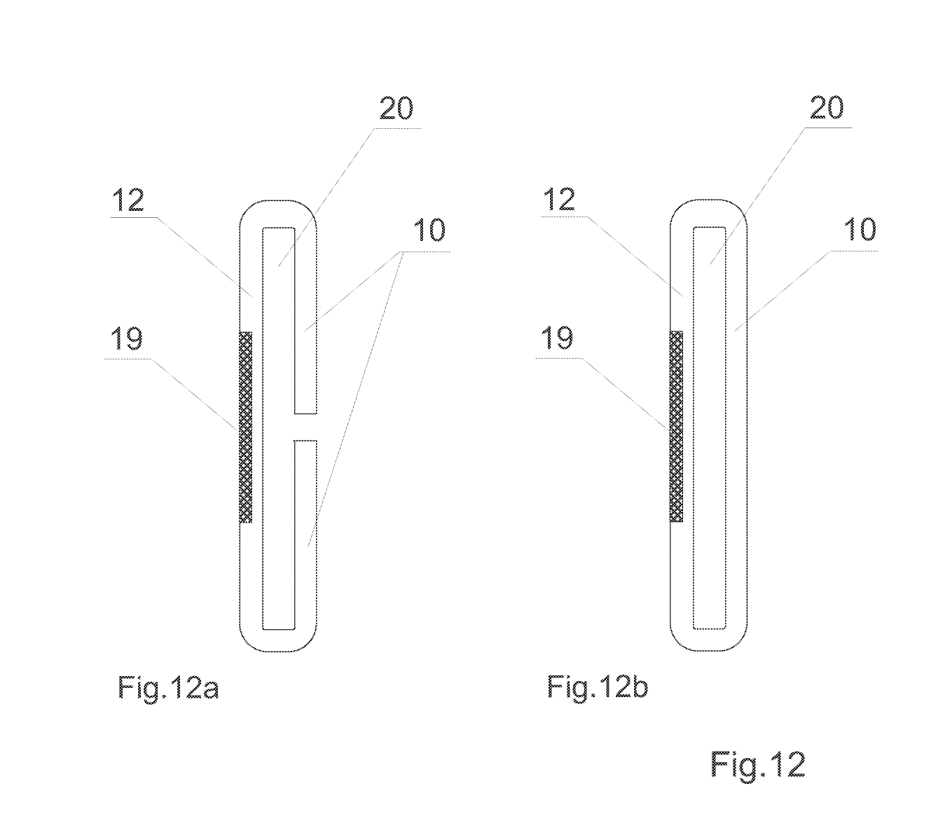

(vi) the clamp 3 can be formed as a tube having a C-like cross-section (mostly used for sheet materials capable of bending), or, optionally, a 0-like cross-section (mostly used for materials capable of casting) as shown in FIGS. 12a and 12b respectively.

### V. Design Ramifications

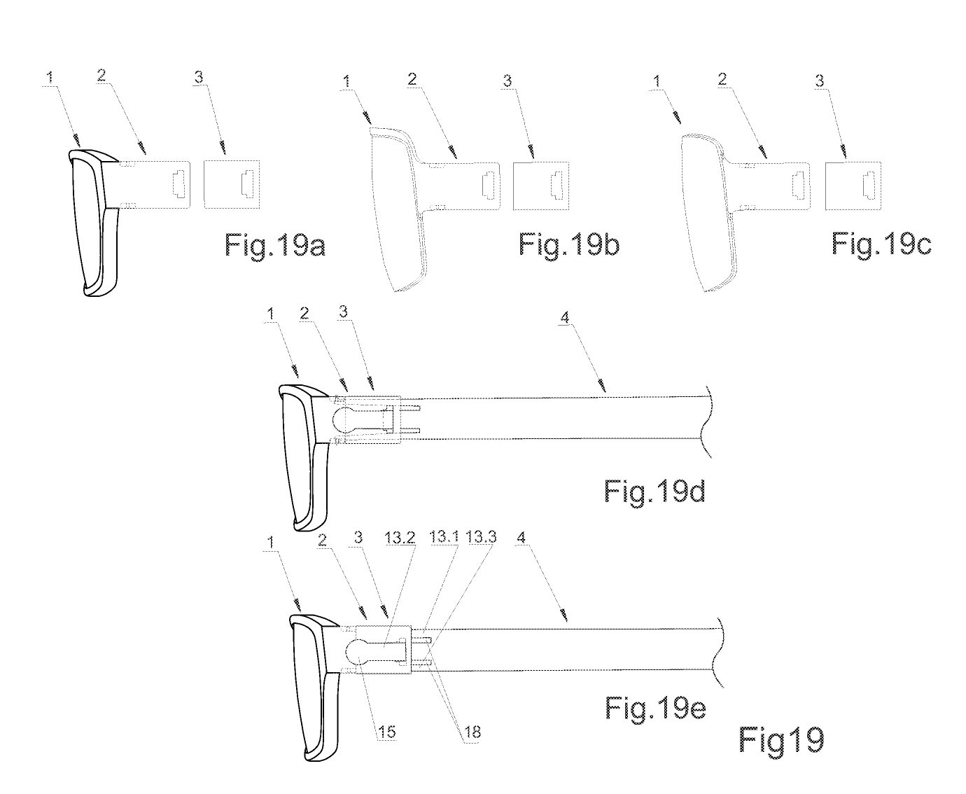

The inventive frame can be adapted for eyewear glass frames having solid rims without any split, or for semi-rimless frames without a split, or rimless frames without a split (shown in FIG. 19). In such design ramifications, the hinge part of the above-described frame can be utilized. In these ramifications, the endpiece does not need to have a split, but still includes: an upper hinge loop (6) and a lower hinge loop (6); a window (8) for receiving the middle prong (13.2) of the temple (4). The joint clamp (3) with the window (11) and the grove (19), as well as the temples (4) will have design structures identical or similar to those described above for the instant invention.

The inventive frame may be used by an average consumer without specific professional skills, who could replace the temples of another style, or color, or material (such as metal, plastic, carbon fiber, titanium, wood, rubber etc.).

1. An eyeglass frame comprising:
(a) a pair of glass-holding rims (1), each said rim (1) is characterized with:
an inner region and
an outer region;
said rims (1) are joined with each other through the inner regions thereof;
each said rim (1) has a rim slit (5) in the outer region thereof;
(b) a pair of endpieces (2) made of a predeterminedly flexible material and angularly coupled to each said rim (1) in the outer region thereof;
said endpiece (2) each includes:
(b1) an essentially flat body characterized with:
longitudinal edges,
a proximal section adjacent to the rim (1),
a distal section remote from the rim (1), and
a middle section, located between said proximal section and said distal section;
said flat body includes a solid part (9) in the distal section;
said flat body is longitudinally split:
within the proximal section, by forming an essentially straight line slit connected to said rim slit (5), and
within the middle section, by forming a curvilined slit (7) and a window (8);
wherein said straight line slit, the curvilined slit (7), and the window (8) are sequentially connected making a common split through the proximal and middle sections; and
(b2) an upper hinge loop (6) and a lower hinge loop (6) angularly coupled to the opposite longitudinal edges of said flat body in the proximal section thereof;
(c) a pair of joint clamps (3) each having a longitudinal axis, a proximal end being proximate to said rim (1), and a distal end being remote from said rim (1); said joint clamp (3) includes:
a window (11) and a groove (19);
said joint clamp (3) is capable of operatively externally sliding along the longitudinal edges of said endpiece (2) until said joint clamp (3) is stopped by the hinge loops (6), and the window (11) essentially coincides with the window (8);
(d) a pair of temples (4) each made of a predeterminedly flexible material, and characterized with a proximal portion being proximate to said rim (1); the proximal portion of said temple (4) includes:
an upper prong (13.1) with a strip-like shape,
a middle prong (13.2), and
a lower prong (13.3) with a strip-like shape;
wherein:
the upper prong (13.1) and the lower prong (13.3) have an equal length and are furnished with outer protrusions (14) coupled thereto; the upper prong (13.1) and the lower prong (13.3) side-wise diverge from the upper prong (13.1) and the lower prong (13.3) in the direction toward said rim (1), thereby forming a widening V-shape with a predetermined diverging angle; said outer protrusions (14) are configured to operatively engage with the upper hinge loop (6) and the lower hinge loop (6) during the assembling of said eyeglass frame;
the upper prong (13.1) and the lower prong (13.3) are spaced from the middle prong (13.2) by recessions (18);
the middle prong (13.2) is longer than the upper prong (13.1) and the lower prong (13.3);
the middle prong (13.2) includes:
a strip-shaped portion most remote from said rim (1), the strip-shaped portion is situated between the upper prong (13.1) and the lower prong (13.3);
a Z-shaped bent portion (17) connected to said strip-shaped portion, said Z-shaped bent portion (17) provides for a step-up forward bend;
a tongue portion (16) having a first end connected to the Z-shaped bent portion (17) and a second end; and
a tip (15) connected to the second end of said tongue portion (16);
said joint clamp (3) is capable of operatively sliding between the recessions (18); and
the tongue portion (16) and the tip (15) are configured to operatively engage with the window (11), the window (8); and the groove (19) is configured to receive a fraction of the middle prong (13.2).

2. The eyeglass frame according to claim 1, wherein the curvilined slit (7) is a waveform configured in one of the following shapes: a jigsaw shape; one semicircle; at least two alternatively bulging semicircles; a broken line.

3. The eyeglass frame according to claim 1, wherein the window (11) and the window (8) are configured in one of the followings shapes: a rectangle; a combination of a first rectangle and a second rectangle being wider than the first rectangle; a ‘sombrero’-like shape; or a shape including at least a portion of sphere or ellipsoid.

4. The eyeglass frame according to claim 1, wherein said common slit further includes a hole (8.1) adjacent to said solid part (9).

5. The eyeglass frame according to claim 4, wherein said hole (8.1) has an oval or round shape.

6. The eyeglass frame according to claim 1, wherein the upper prong (13.1) and the lower prong (13.3) have curvilined ends (21) situated behind the outer protrusions (14).

7. The eyeglass frame according to claim 1, wherein said tip (15) is configured in a shape of at least a portion of a sphere or an ellipsoid; or a ‘mushroom’-like shape; or an arrow-like shape; or a polygon.

8. The eyeglass frame according to claim 1, wherein said joint clamp (3) is formed as a tube having a C-like cross-section, or a 0-like cross-section.

9. The eyeglass frame according to claim 1, wherein said joint clamp (3) further includes:
(c1) an essentially flat clamp base (12) incorporating the window (11) transversely oriented in relation to the longitudinal axis of said joint clamp (3) and located closer to the distal end of said joint clamp (3) than to the proximal end of said joint clamp (3); the clamp base (12) incorporates the groove (19); and
(c2) two wings (10) having a flag-like shape with longer edges coupled with the clamp base (12) and shorter free edges; said wings (10) are folded up such that the free edges meet each other essentially over the longitudinal axis of said joint clamp (3), providing a clamp cutout, and wherein the window (11) and said clamp cutout overlap.

10. The eyeglass frame according to claim 1, wherein said temple (4) is made of one of the following materials: metal, plastic, carbon fiber, titanium, wood, and rubber.

11. A method of assembling said eyeglass frame according to claim 1, said method comprises the steps of:
(A) separating said endpiece (2) along the common split through the proximal and middle sections of the endpiece;
(B) inserting optical lenses into said rim (1) and joining said endpiece (2) along the common split through the proximal and middle sections;
(C) sliding said joint clamp (3) until it fits over said endpiece (2), wherein said joint clamp (3) reaches the loops (6) being stopped thereby, whereas the window (11) essentially coincide with the window (8);
(D) folding the temple (4) down to said rim (1), and sliding said middle prong (13.2) through the window (11) and the window (8);
(E) inwardly depressing the upper prong (13.1) against the lower prong (13.3), thereby narrowing said predetermined diverging angle therebetween, aligning the protrusions (14) of said upper prong (13.1) and said lower prong (13.3) with the corresponding hinge loops (6); and
(F) inserting said outer protrusions (14) into the corresponding hinge loops (6), and releasing said upper prong (13.1) and said lower prong (13.3), thereby completing the assembling of said eyeglass frame.
